(19) United States
(12) Patent Application Publication
(10) Pub. No.: US 2010/0297485 A1
(43) Pub. Date: Nov. 25, 2010

(54) BATTERY COVER

(75) Inventors: ZHAN-SHI REN, Foshan (CN); GUANG-YUAN CHEN, Foshan (CN); RONG-HAO WANG, Foshan (CN)

Correspondence Address: Altis Law Group, Inc.;ATTN: Steven Reiss, 288 SOUTH MAYO AVENUE, CITY OF INDUSTRY, CA, 91789, US

(73) Assignees: PREMIER IMAGE TECHNOLOGY(China) LTD., Foshan City (CN); HON HAI PRECISION INDUSTRY CO., LTD., Tu-Cheng (TW)

(21) Appl. No.: 12/558,580

(22) Filed: Sep. 14, 2009

(30) Foreign Application Priority Data
May 25, 2009 (CN) 200910302596.X

(51) Int. Cl. H01M 2/10

(52) U.S. Cl. 429/100

(57) ABSTRACT

A battery cover for connecting to a portable electronic device pivotably via a pivot, includes a front cover, a bottom board connected to the front cover and a metal dome fixed between the front cover and the bottom board. The front cover includes a main body, a slide board, a resilient member and a fixing mat. The main body defines a front end adjacent to the pivot and a rear end opposite to the front end. An opening is disposed on the rear end and a first positioning groove is disposed between the front end and the opening. The slide board includes an operation button exposed out of the opening and is operable for slidably engaging with or disengaging from the portable electronic device. The resilient member is received in the first positioning groove and connecting to the slide board. The fixing mat is configured for fixing the slide board and resilient member on the main body.

### BACKGROUND

1. Technical Field

The present disclosure relates to electronic devices and, particularly, to a battery cover used in a portable electronic device such as a projector, a camera, a notebook computer, or a mobile phone.

2. Description of Related Art

Typically, a battery cover is connected to a sidewall of a housing of a battery compartment via a number of engaging portions respectively received in a number of preset corresponding locked positions wherein the cover generally cannot be unlocked without pushing operation acted on the battery cover. In this way, the weight of the battery cover needs to be taken into account when opening the battery cover. It is inconvenient for users.

Therefore, it is desirable to provide a battery cover, which can overcome or at least alleviate the above-mentioned problems.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-section view of a battery cover, in a closed state, according to an exemplary embodiment.

FIG. 2 is similar to FIG. 1, but showing the battery cover in an opening state.

FIG. 3 is an isometric, exploded view of the battery cover of FIG. 1.

FIG. 4 is similar to FIG. 3, but showing the battery cover from an inverted perspective.

FIG. 5 is an isometric, partially exploded view of the battery cover of FIG. 3.

FIG. 6 is an isometric, assembled view of the battery cover of FIG. 3.

FIG. 7 is similar to FIG. 6, but showing the battery cover from an inverted perspective.

### DETAILED DESCRIPTION

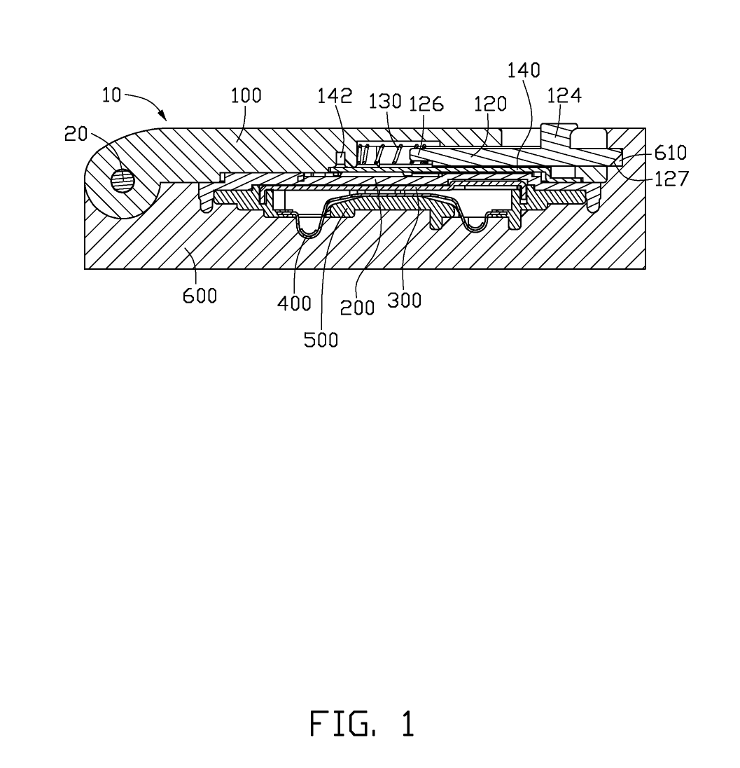

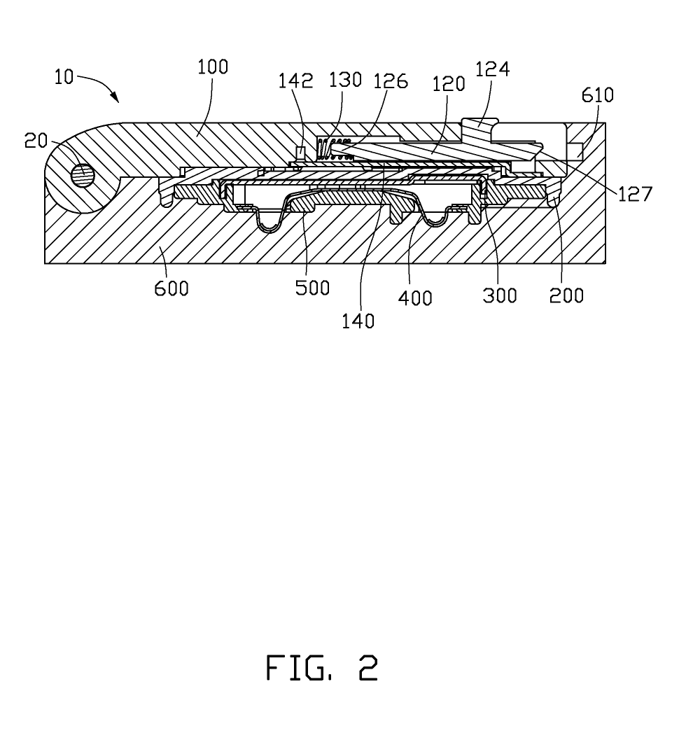

Referring to FIGS. 1 and 2, a battery cover 10 used in a portable electronic device 600 such as a projector, a camera, a notebook computer, or a mobile phone, is shown. The battery cover 10 is pivotably connected to the portable electronic device 600 via a pivot 20 disposed on an end of the battery cover 10. The portable electronic device 600 defines an engaging groove 610 for receiving another end of the battery cover 10 therein.

The battery cover 10 includes a front cover 100, a waterproof sheet 200, a protection sheet 300, a metal dome 400 and a bottom board 500.

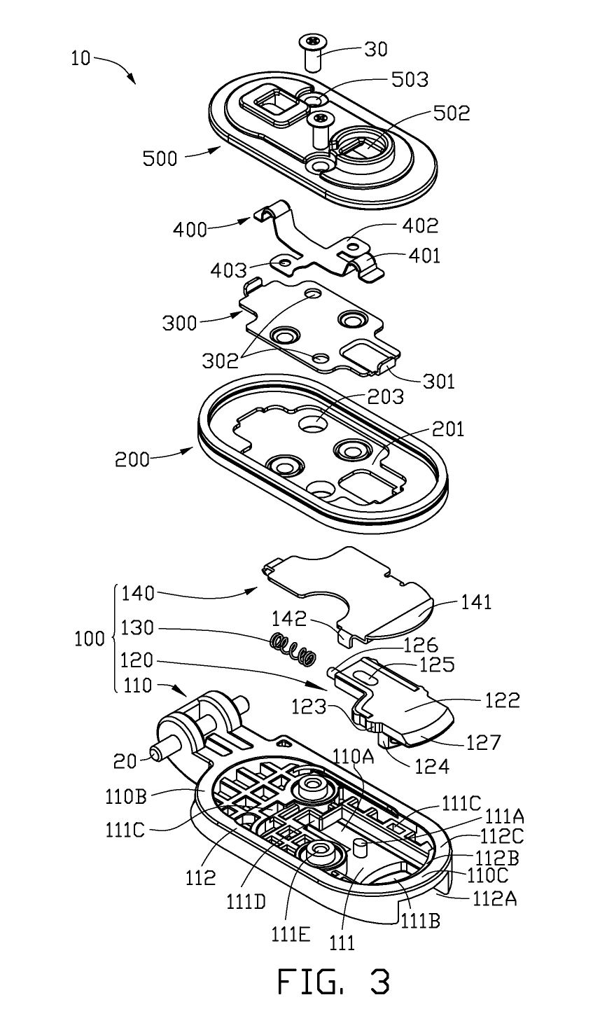

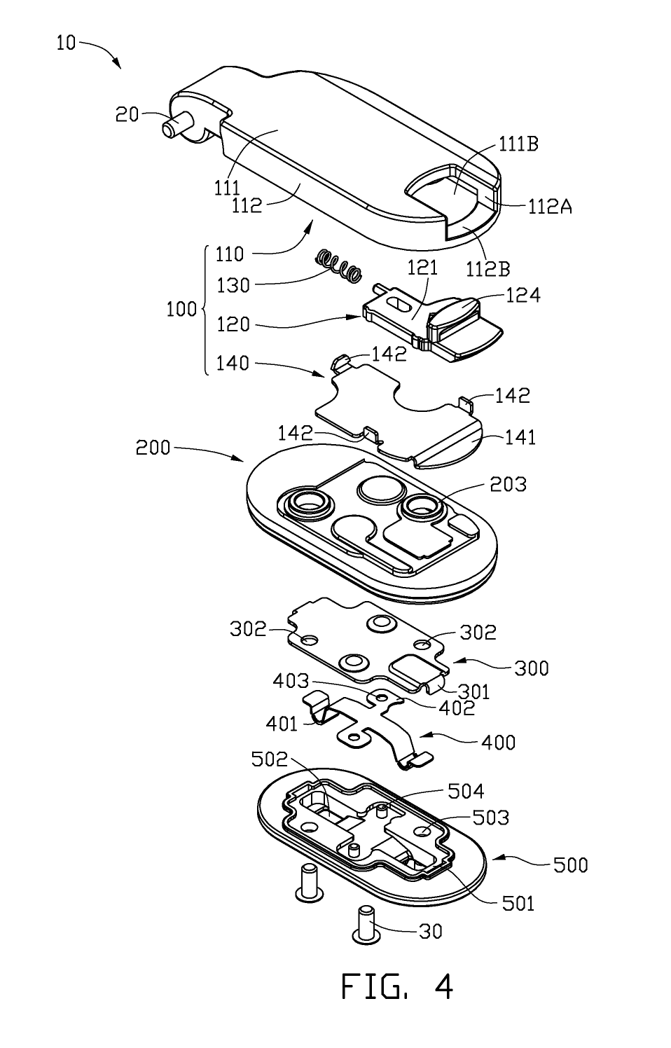

Referring to FIGS. 3 and 4, the front cover 100 includes a main body 110 pivotably connected to the portable electronic device 600 via the pivot 20 fixed on an end thereof. The main body 110 defines a receiving cavity 110A thereof. A slide board 120, a resilient member 130 and a fixing mat 140 are received in the receiving cavity 110A.

The main body 110 includes a base board 111 and a sidewall 112 perpendicularly extending downward from an edge of the base board 111. The sidewall 112 and the base board 111 cooperatively define the receiving cavity 110A. The base board 111 includes a front end 110B adjacent to the pivot 20 and a rear end 110C away from the pivot 20. The base board 111 defines a guiding pin 111A between the front end 110B and the rear end 110C to extend towards the portable electronic device 600. The base board 111 also defines an opening 111B on the rear end 110C, three latching grooves 111C around the guiding pin 111A, a first positioning groove 111D disposed between the front end 110B and the guiding pin 111A, and two first screw holes 111E oppositely disposed beside the first positioning groove 111D. The opening 111B passes through the base board 111. The sidewall 112 defines a cutout 112A communicated with the receiving cavity 110A and the opening 111B, and a slanted portion 112B extending along the inside surface of the sidewall 112 on the rear end 110C towards the front end 110B. A space is defined between the slanted portion 112B and an end surface 112C of the sidewall 112.

The slide board 120 includes a first surface 121 facing the base board 111, a second surface 122 opposite to the first surface 121, and a number of side surfaces 123 connecting the first surface 121 to the second surface 122. The first surface 121 includes an operation button 124 exposed out of the opening 111B of the base board 111. A through hole 125 is disposed on the slide board 120 passing through the first surface 121 and the second surface 122 for receiving the guiding pin 111A therein. The length of the through hole 125 along a direction perpendicular to the pivot 20 is larger than that of the guiding pin 111A. The side surface 123 of the slide board 120 adjacent to the pivot 20 includes a protrusion 126 extending towards the pivot 20. The side surface 123 opposite to the protrusion 126 includes an incline 127 thereon. The resilient member 130 is sleeved on the protrusion 126.

The fixing mat 140 includes a step portion 141 respecting to the slanted portion 112B and three connecting arms 142 extending from the corresponding three lateral sides thereof to be received in the latching grooves 111C, respectively.

The waterproof sheet 200 is made of plastic. The outer contour of the waterproof sheet 200 is substantially matched with the inner contour of the receiving cavity 110A of the front cover 100. The waterproof sheet 200 defines a matching groove 201 for receiving the protection sheet 300 and two second screw holes 203 corresponding to the first screw holes 111E, respectively. The contour of the matching groove 201 is substantially same to that of the protection sheet 300.

The protection sheet 300 is made of metal. The protection sheet 300 is disposed between the metal dome 400 and the waterproof sheet 200 for protecting the metal dome 400 from damaging the waterproof sheet 200. The protection sheet 300 includes a pair of opposite positioning protrusions 301 respectively formed on two lateral edges thereof and two third screw holes 302 corresponding to the second screw holes 203 respectively. The positioning protrusions 301 are received in the corresponding second positioning grooves 501 defined on the bottom board 500.

The metal dome 400 has a strip-shaped configuration, and includes two arc-shaped protrusions 401 formed at two opposite ends thereof and two fixing pieces 402 formed on two lateral sides thereof. Each fixing piece 402 defines a positioning hole 403 thereon.

The bottom board 500 defines two conducting holes 502, two fourth screw holes 503 corresponding to the third screw holes 302, and two positioning pins 504 extending towards the protection sheet 300. The two conducting holes 502 are configured for receiving the two arc-shaped protrusions 401 of the metal dome 400. The arc-shaped protrusions 401 are configured for contacting with poles of a battery (not shown) received in the portable electronic device 600 through the conducting holes 502. Two screws 30 (shown in FIG. 3) run through the fourth screw holes 503, then extend through the two third screw holes 302 of the protection sheet 300 and the two second screw holes 203 of the waterproof sheet 200 to screw into the first screw holes 111E, for connecting the bottom board 500 to the front cover 100 and fixing the waterproof sheet 200 and the protection sheet 300 therebetween. The two positioning pins 504 are received in the positioning holes 403 of the metal dome 400 for positioning the metal dome 400 on the bottom board 500.

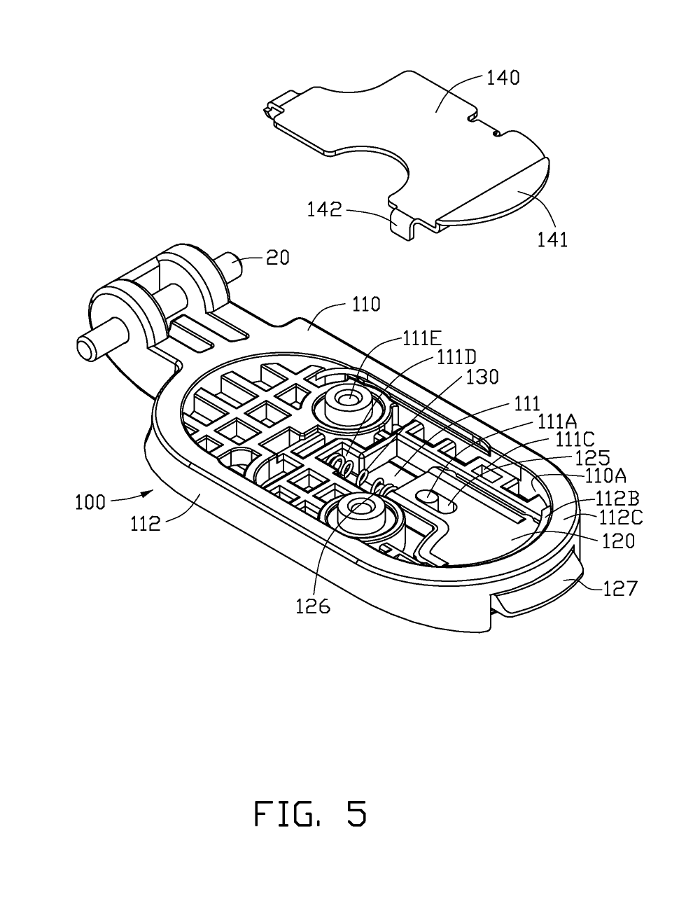

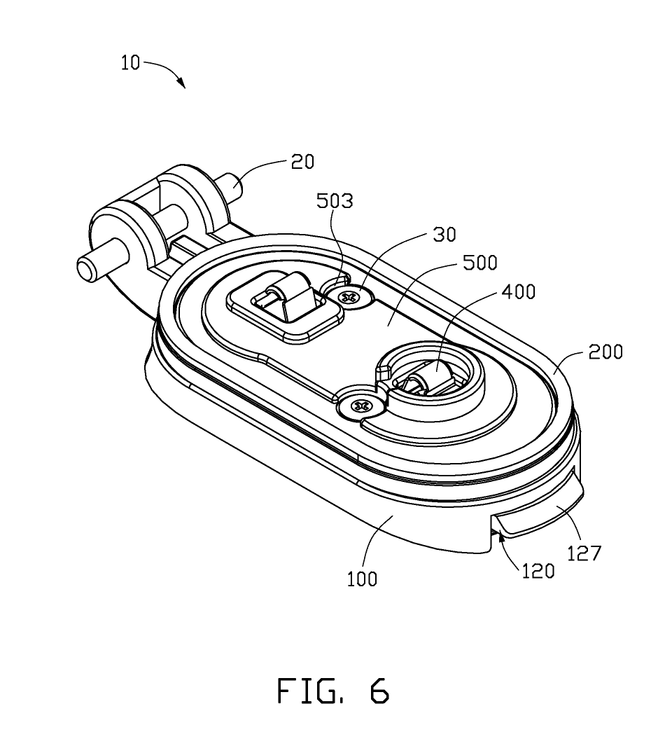

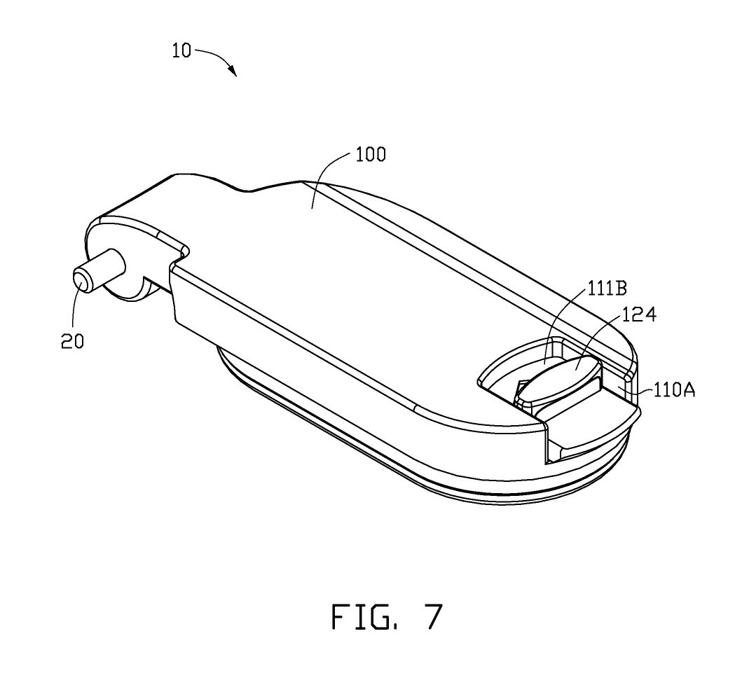

Referring to FIGS. 5-7, together with FIG. 4, in assembly, firstly, the resilient member 130 is sleeved on the protrusion 126 of the slide board 120 and received in the first positioning groove 111D. The operation button 124 is exposed out of the opening 111B while the slide board 120 is received in the receiving groove 110A, with the positioning pin 111A of the front cover 110 passing through the through hole 125 of the slide board 120. And then the incline 127 of the slide board 120 is exposed out of the cutout 112A of the sidewall 112, to be received in the latching groove 610. The fixing mat 140 is positioned on the front cover 110 when the connecting arms 142 are received in the corresponding latching grooves 111C. The step portion 141 is received in the space between the slanted portion 112B and the end surface 112C of the sidewall 112. The waterproof sheet 200 is received in the receiving cavity 110A by matching the outer side surface thereof to the inner side surface of the sidewall 112 of the front cover 110. Secondly, the metal dome 400 is positioned on the bottom board 500 by positioning the positioning pins 504 in the positioning holes 403, respectively. The protection sheet 300 is fixed to the bottom board 500 by latching the positioning protrusions 301 thereof to the second positioning grooves 501 of the bottom board 500. Thirdly, the protection sheet 300 is positioned on the matching groove 201 (shown in FIG. 3), to fix the protection sheet 300 to the waterproof sheet 200. At last, the screws 30 are engaged into the fourth screw holes 503, the third screw holes 302, the second screw holes 203, and the first screw holes 111E in sequence, for connecting the front cover 110 to the bottom board 500.

Referring to FIGS. 1 and 2, when opening the battery cover 10, the operation button 124 is pushed to an end of the opening 110A, towards the pivot 20, so that the resilient member 130 is compressed and the incline 127 of the slide board 120 can be escaped from the latching groove 610. Then, the battery cover 10 can be opened by a pulling force on the front cover 11. Because the operation of opening the battery cover 10 only requires sliding movements on the operation button 124, the weight of the battery cover 10 will not be taken into account and users may feel more convenient. When the battery cover 10 needs to be closed onto the portable electronic device 600, it can be pushed towards the portable electronic device 600 such that the incline 127 slides against an edge of the portable electronic device 600 above the latching groove 610 while being pushed to slide towards the pivot 20 until the incline 127 aligns with and clasps into the latching groove 610.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A battery cover connected to a portable electronic device via a pivot, comprising:
a front cover comprising:
a main body defining a front end adjacent to the pivot and a rear end opposite to the front end, an opening disposed on the rear end and a first positioning groove disposed between the front end and the opening;
a slide board slidably disposed on the main body and comprising an operation button exposed out of the opening, the slide board being operable for slidably engaging with or disengaging from the portable electronic device;
a resilient member received in the first positioning groove and connected to the slide board; and
a fixing mat latched to the main body for fixing the slide board and the resilient member on the main body;
a bottom board connected to the main body; and
a metal dome fixed between the front cover and the bottom board to pass throughout the bottom board for electrically contacting a battery received in the portable electronic device.

2. The battery cover in claim 1, further comprising a waterproof sheet connected to the front cover and a protection sheet fixed between the waterproof sheet and the metal dome.

3. The battery cover in claim 2, wherein the waterproof sheet defines a matching groove for receiving the protection sheet, the contour of the matching groove is substantially same to that of the protection sheet.

4. The battery cover in claim 2, wherein the main body comprises a base board and a sidewall extending towards the bottom board from an edge of the base board, the sidewall and the base board cooperatively defines a receiving cavity, and the waterproof sheet is received in the receiving cavity.

5. The battery cover in claim 4, wherein the base board comprises a guiding pin formed between the front end and the rear end and extending towards the waterproof sheet, and the slide board defines a through hole for receiving the guiding pin, and the first positioning groove is disposed between the front end and the guiding pin.

6. The battery cover in claim 5, wherein the fixing mat comprises a plurality of connecting arms extending from the lateral sides thereof, and the base board defines a plurality of latching grooves around the guiding pin for receiving the corresponding connecting arms therein.

7. The battery cover in claim 4, wherein the sidewall defines a cutout communicated with the receiving cavity and the opening.

8. The battery cover in claim 1, wherein the slide board comprises a first surface facing the front cover, a second surface opposite to the first surface, and a plurality of side surfaces connected the first surface to the second surface, the operation button is disposed on the first surface and exposed through the opening, one side surface of the slide board adjacent to the pivot comprises a protrusion towards the pivot, and another side surface opposite to the protrusion comprises an incline, the resilient member is sleeved on the protrusion.

9. The battery cover in claim 8, wherein a through hole for receiving the guiding pin is disposed on the slide board passing through the first surface and the second surface, the length of the through hole along a direction perpendicular to the pivot is larger than that of the guiding pin.

10. The battery cover in claim 2, wherein the metal dome comprises two arc-shaped protrusions formed beside two ends thereof and two fixing pieces formed on two lateral sides thereof, each fixing piece defines a positioning hole thereon, the bottom board defining two positioning pins towards the protection sheet are received in the positioning holes respectively.

11. The battery cover in claim 10, wherein the bottom board defines two conducting holes for passing therethrough the two arc-shaped protrusions to connect to corresponding poles of the battery.

12. The battery cover in claim 2, wherein the protection sheet comprises a pair of opposite positioning protrusions respectively formed on two lateral edges thereof, the bottom board further comprises two positioning grooves for receiving the positioning protrusions.

13. The battery cover in claim 2, wherein the front cover defines two first screw holes, the waterproof sheet defines two second screw holes corresponding to the first screw holes, the protection sheet defines two third screw holes corresponding to the second screw holes, and the bottom board defines two fourth screw holes corresponding to the third screw holes, and two screws run through the fourth screw holes, then extend through the two third screw holes and the two second screw holes, and are finally screwed into the first screw holes, to connect the bottom board to the front cover and fix the waterproof sheet and the protection sheet therebetween.
